(19) United States
(12) Patent Application Publication
(10) Pub. No.: US 2024/0426859 A1
(43) Pub. Date: Dec. 26, 2024

(54) AIR-FREE TRANSFER VESSEL FOR MULTIPLE DIAGNOSTIC TOOLS

(71) Applicant: SOLID DESIGN INSTRUMENTS, LLC, Sugar Land, TX (US)

(72) Inventors: Zheng FAN, Sugar Land, TX (US); Yan YAO, Sugar Land, TX (US)

(73) Assignee: SOLID DESIGN INSTRUMENTS, LLC, Sugar Land, TX (US)

(21) Appl. No.: 18/341,051

(22) Filed: Jun. 26, 2023

(51) Int. Cl. G01N 35/10; G01N 35/04

(52) U.S. Cl. CPC G01N 35/1067; G01N 35/04; G01N 2035/0403

(57) ABSTRACT

A hermetically sealable transfer vessel provides a cover, base, drive system, and sample platform. The cover and base may form a sealed space around the sample platform. A transparent window may be provided for the cover. The drive system provides a securing mechanism that allows the cover to be opened and closed. A mechanical lift is provided that allows the sample platform to be adjusted vertically. The transfer vessel is suitable for several mainstream analytical instruments, including focus ion beam (“FIB”) instruments. The transfer vessel allows samples to be analyzed by multiple analytical instruments, thereby allowing multi-physics characterizations on an individual sample.

### CROSS REFERENCE TO RELATED APPLICATIONS

This application relates to, but does not claim priority from, U.S. Ser. No. 63/042,741, filed Jun. 23, 2020, the entire contents of which are incorporated herein fully by reference.

### GOVERNMENT LICENSE RIGHTS

This invention was made with government support under Contract DE-EE0008864 awarded by the U.S. Department of Energy's Office of Energy Efficiency and Renewable Energy (“EERE”) under the Vehicle Technologies Program. The government has certain rights in the invention.

### TECHNICAL FIELD

This disclosure relates to an air-free transfer vessel for multiple diagnostic tools.

### DESCRIPTION OF THE RELATED ART

This section of this document introduces information about and/or from the art that may provide context for or be related to the subject matter described herein and/or claimed below. It provides background information to facilitate a better understanding of the various aspects of the present invention. This is a discussion of “related” art. That such art is related in no way implies that it is also “prior” art. The related art may or may not be prior art. The discussion in this section of this document is to be read in this light, and not as admissions of prior art.

Analysis of air sensitive specimens, such as in situ, may be desirable in various situations. As a nonlimiting example, such analysis may be desirable for batteries. Further examples of areas where such analysis may be desirable may include the batteries of PCT publication Nos. WO2017/156518 titled “High ionic conductivity researchable solid state batteries with an organic electrode” and WO2019/140368 “Solid electrolyte for sodium batteries.”

### SUMMARY

A transfer vessel that is suitable for transit between several mainstream analytical instruments is disclosed herein. Nonlimiting examples include Scanning Electron Microscope (“SEM”), Focused Ion Beam (“FIB”), including slice-and-view tomography, X-ray diffraction spectroscopy, Raman spectroscopy, and/or the like. The disclosed transfer vessel is an “isolation transfer vessel” because it isolates a sample from the ambient atmosphere during transport between two tools.

Generally, a hermetically sealable transfer vessel provide a cover, a base, a drive system, a sample platform, and a mechanical lift. In some embodiments, the cover and the base form a sealed space around the sample platform when closed. In some embodiments, a transparent, sealed observation window is provided by the cover. In some embodiments, the drive system provides a securing mechanism that allows the cover to be opened/unsealed and closed/sealed. In some embodiments, a mechanical lift allows the sample platform to be adjusted vertically. In some embodiments, the transfer vessel is suitable for several mainstream analytical instruments, such as SEM, FIB including slice-and-view tomography, X-ray diffraction spectroscopy, Raman spectroscopy, and/or the like. In some embodiments, the transfer vessel allows specimens to be analyzed by multiple analytical instruments, thereby allowing multi-physics characterizations on an individual sample.

More particularly, in a first aspect, an isolation transfer vessel, comprising a base, a cover, a drive system, and sample platform, and a mechanical lift. The drive system, in use, translates the cover between an open position and a closed position. The cover forming a hermetic seal with the base when in the closed position. The sample platform is disposed within the base. The mechanical lift raises the sample platform as the cover translates to the open position and permits the sample platform to lower as the cover translates to the closed position.

In a second aspect, a method for use in inspecting samples on diagnostic tools begins by opening a hermetically sealed isolation transfer vessel in an air-free environment. The opening of the isolation transfer vessel mechanically raises a sample platform and exposes the interior of the isolation transfer vessel to the air-free environment. A mounted specimen is then disposed on the sample platform. The method then closes the isolation transfer vessel. The closing of the isolation transfer vessel allows the sample platform to lower and hermetically seals the mounted specimen on the sample platform within the isolation transfer vessel. The closed isolation transfer vessel in which the mounted specimen is hermetically sealed is then transported to a first diagnostic tool, where the mounted specimen is inspected using the first diagnostic tool.

The above presents a simplified summary of the invention as claimed below in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

### BRIEF DESCRIPTION OF THE DRAWINGS

The invention may be understood by reference to the following description taken in conjunction with the accompanying drawings, in which like reference numerals identify like elements, and in which:

FIGS. 1A-1B depict, in an open position and a closed position, respectively, an isolation transfer vessel compatible with multiple diagnostic tools in accordance with one or more embodiments. Both FIG. 1A and FIG. 1B are top, elevational views of the isolation transfer vessel with the cover shown ghosted in FIG. 1A.

FIGS. 2A-2B illustrate the operations of the sample platform of the isolation transfer vessel of FIGS. 1A-1B in a top elevational view and a plan side view, respectively. In FIG. 2A, the cover of the isolation transfer is shown ghosted and in both FIGS. 2A-2B some aspects of the isolation transfer vessel are omitted to better illustrate the operations.

FIGS. 3A-3B show applications of an isolation transfer vessel in a diagnostic tool in accordance with one or more embodiments.

FIGS. 4A-4C show applications of an isolation transfer vessel in a diagnostic tool in accordance with one or more embodiments.

FIG. 5 shows the operation of an isolation transfer vessel in a chamber-free device in accordance with one or more embodiments.

FIG. 6A and FIG. 6B are top, elevational views of an isolation transfer vessel in an open position in accordance with one or more embodiments.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the subject matter claimed below will now be disclosed. In the interest of clarity, not all features of an actual implementation are described in this specification. It will be appreciated that in the development of any such actual embodiment, numerous implementation-specific decisions will be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Analyses such as those discussed above may involve transport between two or more tools in a “transfer vessel”. Conventional transfer vessels for protecting sensitive substances from the sampling environment when moved to an analytical tool are limited for use with a specific type of diagnostic tool. Further, such transfer vessels are not suitable for focused ion beam tools. Thus, conventional transfer vessels have very limited compatibility and there are some diagnostic tools that lack any suitable transfer vessel options.

Because the transfer vessels are limited to single devices or types of tools, samples cannot undergo multiple, differing analysis/diagnostic processes, such as SEM and X-ray diffraction. Further, some analytical instruments or diagnostic devices lack any suitable transfer vessels. As a nonlimiting example, FIB, which is a significant technique in the materials sciences for the fundamental morphological studies, lacks a suitable transfer vessel. FIB positions the as-analyzed specimen on the highest position of the sample stage, which provides barriers for conventional transfer vessels.

An air-free, or isolation transfer vessel suitable is disclosed herein that is compatible with multiple state-of-the-art diagnostic tools applying materials science characterization techniques for an air-sensitive specimen. Such an isolation sealing vessel can transfer a sample from the glove box to the analytical instruments with a vacuum chamber for further characterization. Furthermore, the isolation transfer vessel protectively seals the specimen for the air-free characterizations with the instruments, including, without limitation, SEM, FIB including slice-and-view tomography, X-ray diffraction spectroscopy, Raman spectroscopy, and/or the like.

In some embodiments, the isolation transfer vessel allows specimens to be analyzed by multiple analytical instruments, thereby allowing multi-physics characterizations on an individual sample. Thus, one sample can go through a series of analytical tools without exposure or the release/reinstallation of different holders. Multi-dimensional structural, chemical, mechanical, electrical, biological, and/or other diagnosis of the sample can be implemented for an in-depth understanding of the mechanical, physical, and/or chemical properties. Moreover, the vessel and the corresponding multi-dimensional diagnostic processes are especially suitable for in situ characterization.

In some embodiments, a hermetically sealable isolation transfer vessel provides a cover, a base, a drive system, a sample platform, and a mechanical lift. The cover and base form a sealed space around the sample platform when closed. In some embodiments, a transparent, sealed observation window is provided by the cover. In some embodiments, the drive system provides a securing mechanism that allows the cover to be opened/unsealed and closed/sealed. In some embodiments, a mechanical lift is provided that allows the sample platform to be adjusted vertically.

In some embodiments, the isolation transfer vessel is suitable for several mainstream analytical instruments, such as SEM, FIB including slice-and-view tomography, X-ray diffraction spectroscopy, Raman spectroscopy, and/or the like. In some embodiments, the isolation transfer vessel allows specimens to be analyzed by multiple analytical instruments, thereby allowing multi-physics characterizations on an individual sample. Embodiments of the isolation transfer vessels disclosed herein are compatible with multiple state-of-the-art materials characterization. Nonlimiting examples include SEM, FIB including slice-and-view tomography, X-ray diffraction spectroscopy, Raman spectroscopy, and/or the like.

Moreover, embodiments of the isolation transfer vessel allows multi-physics characterizations on an individual sample through multiple analytical instruments. Embodiments of the isolation transfer vessel permit the combination of the analytical measurements on different devices for the in-depth understanding of the coupling structural-chemical-mechanical properties. Thus, the isolation transfer vessel can be used as an intermediate junction for the future automated and programmable multi-technique diagnostics, enabling the efficient utilization of the analytical instrument resources.

Embodiments of isolation the transfer vessel provide a hermetically sealed testing vessel for in situ characterizing air-sensitive specimens and transferring between multiple diagnostic tools without exposure to air. The isolation transfer vessel comprises a cover for protecting the specimen from air exposure during transit, use, storage, and at any other desired times.

Two testing modes are available for the vessel: in-chamber tests, and protective atmosphere tests. For the in-chamber tests, a sample platform embedded in the vessel will be lifted to the highest horizontal altitude for the exposure of the specimen during the opening. Alternatively, for instrument tools without a vacuum chamber, a transparent membrane placed on the vessel cover permits protective atmosphere tests of the specimen.

Embodiments of the isolation transfer vessel are flexible and addresses the key challenges for characterizing a variety of air-sensitive specimens in situ or moving among various instruments without exposure to air. This isolation transfer vessel is suitable for a wide variety of technology areas, including but not limited energy, batteries, biological, medical, and/or any other areas.

One objective of embodiments of the transfer vessel is to provide a flexible test apparatus that is compatible with multiple state-of-the-art materials characterization techniques, such as for an air-sensitive solid-state battery specimen. The sealing vessel can transfer the specimen from the isolated storage (e.g., glove box) to the analytical instruments (e.g., SEM, FIB slice-and-view tomography, etc.) with a vacuum chamber for further characterizations. Also, the transfer vessel permits the protective sealing of the specimen for the air-free characterizations with the analytical instruments, such as but not limited to Raman spectroscopy, X-ray diffraction analysis, etc.

Embodiments may also implement multi-dimensional diagnostics of the specimen through the testing vessel. Once installed on the isolation transfer vessel, the specimen can go through a series of analytical instruments, without the release/reinstallation on different holders or exposure. Then, a multi-dimensional structural-chemical-mechanical-electrical-biological diagnostics toolsets can be applied to the specimen for an in-depth understanding of the physical and/or chemical properties. The present isolation transfer vessel and its corresponding multi-dimensional diagnostic processes can address the challenges for characterizing a variety of air-sensitive specimens, enabling the applications in areas of energy, batteries, biological, medical, and/or any other areas.

As a nonlimiting example, all-solid-state batteries (“ASSBs”) promise an exciting future to be the next-generation energy storage system on account of the lithium metal anodes with high areal capacity and the solid-state electrolytes with critical safety. Recently, the novel organic electrodes have been reported to have the potential to provide up to 3× the capacity of standard Li-ion batteries.

Unfortunately, the poor compatibility between solid electrolyte and electrode in the ASSB design results in a kinetically unstable interface. This interface poses a significant hurdle towards the design of high-performance solid-state batteries for the fast recharge requirement, such as for electric vehicles (“EVs”), hybrid EVs, and smart grids. The time-resolved operando techniques (e.g., in situ microscopy, synchrotron X-ray tomography, or the like) are ideal for the direct and quantitative characterization of the interfacial deteriorations. Many believe that the combination of multiple in situ techniques for multi-dimensional diagnostics will be the ultimate solution for probing the secret of solid-state batteries.

However, the in situ analysis of the solid-state battery is still in its primary stage. The sensitive nature of the solid-state battery requires a transfer vessel for the protection from the specimen storage to the characterization instrument. To the best of our knowledge, the existing protective atmosphere vessels are limited to being used in a specific analytical tool, and no multi-purpose systematic vessels exist in the market. Therefore, the limited functionality of the current transfer vessel systems prevents the in-depth understanding of the ASSBs through the multi-physics diagnosis and requires analysis of multiple samples introducing inconsistency. In addition to the study of ASSBs, the isolation transfer vessel disclosed herein may have applications in the fundamental investigations of a wide variety of materials in a wide variety of technology areas where in situ multi-physics diagnosis through a multi-purpose platform is desirable, such as but not limited to functional nanomaterials for energy, biological, and/or medical applications.

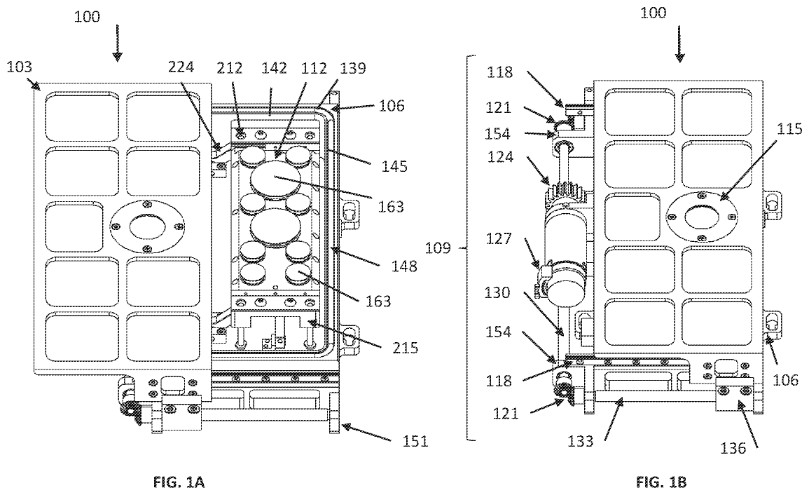

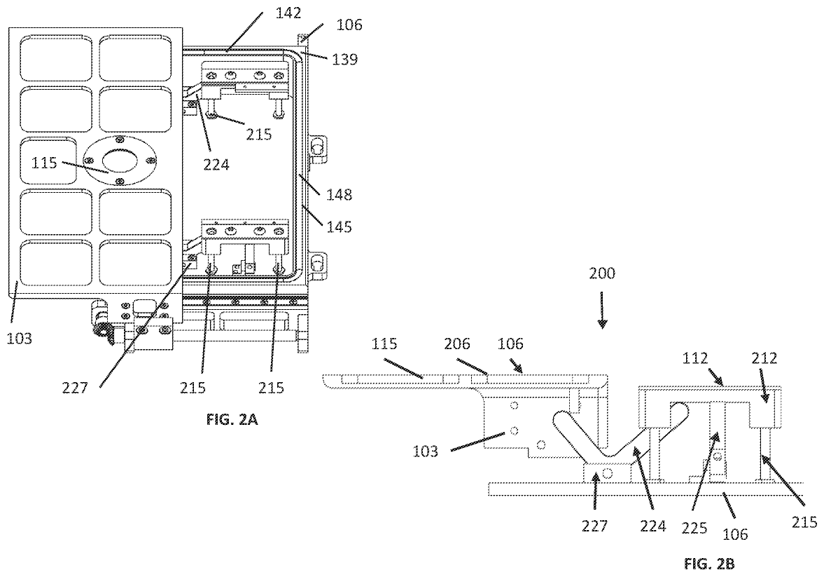

Turning now to the drawings, FIGS. 1A-1B depict, in an open position and a closed position, respectively, an isolation transfer vessel 100 compatible with multiple diagnostic tools in accordance with one or more embodiments. FIGS. 2A-2B illustrate the operations of the sample platform 112 of the isolation transfer vessel 100 of FIGS. 1A-1B. Referring collectively; to FIGS. 1A-1B and 2A-2B, the isolation transfer vessel 100 comprises, in this particular embodiment, a cover 103, a base 106, a drive system 109, a sample platform 112, and a mechanical lift 200 (shown best in FIGS. 2A-2B).

Note that the cover 103 is illustrated in “ghosted” form in FIGS. 1A, 2A to help illustrate features of the isolation transfer vessel 100 that might otherwise be obscured. The cover 103 may include, in a nonlimiting example, an observation window 115, shown best in FIG. 1B. The observation window 115 comprises, as best shown in FIG. 2B, a window opening 203 defined by the cover 103 and sealed by a translucent pane 206 (e.g., quartz glass). The translucent pane 206 seals the window opening 203 to maintain the hermetic seal of the isolation transfer vessel 100 when the cover 103 is in the closed position.

The observation window 115 provides a means for examining the sample in chamber-free tools or instruments. The size and location of the observation window 115 are not material so long as it is large enough and positioned such that the desired examination can be conducted. The observation window furthermore is beneficial in embodiments in which the cover 103 is otherwise fabricated from a material opaque to the kinds of electromagnetic energy used in commonly encountered diagnostic tools and examination instruments.

Some embodiments may omit the observation window 115. For example, in some embodiments the entire cover(s) 103 may be fabricated of a material translucent to the kinds of electromagnetic energy mentioned above. Or, some embodiments may be designed for use only with diagnostic tools and examination instruments having air-free chambers may also omit the observation window 115. However, these embodiments may be limited to use with diagnostic tools having air-free chambers and are not compatible with diagnostic tools without such air-free chambers.

The drive system 109 translates the cover 103 between an open position, shown in FIG. 1A, and a closed position, shown in FIG. 1B in a manner discussed more fully below. Referring now to FIG. 1B, the drive system 109 in this embodiment may include brackets 118, bevel gears 121, a transmission gear 124, a vacuum-compatible motor 127, a drive shaft 130, a worm screw 133, and a sleeve adapter 136 between the worm screw 133 and the cover 103. The vacuum-compatible motor 127 is powered by a mechanism not shown, which could be, for example, a battery or switched power from the electrical main of a facility.

As best shown in FIGS. 1A and 2A, the base 106 in the illustrated embodiment is a basin having a lip 139 at the top thereof defining a top opening 142. The lip 139 also defines a continuous recess 145 therein in which is disposed an elastomeric sealing element 148. In the illustrated embodiment, the elastomeric sealing element 148 is an O-ring. A nonlimiting example of base 106 may also include accessories, such as but not limited to shaft adapter 151 and/or worm adapter 154.

The sealing element 148 disposed in the recess 145 is, by way of example and illustration, but one means for hermetically sealing the juncture between the cover 103 and the base 106 when the cover 103 is in the closed position. Other embodiments (not shown) may employ other means having equivalent structures to effect this seal. Still other embodiments may use still other types of sealing techniques to effect this seal.

As best shown in FIG. 1A, the sample platform 112 includes an upper surface 157 that defines two recesses 160. This portion 112 of the sample platform 112 is a stage 163 upon which a mounted sample (not shown) may be disposed. The embodiment shown includes multiple sample stages 163 of varying sizes. However, some embodiments (not shown) may include as few as one sample stage or multiple sample stages all of the same size. The recesses 160 mate with buttons (not shown) on the bottom of the mount (not shown) for the sample to stabilize the mounted sample on the stage 163. Some embodiments may also including securing mechanisms (not shown), such as clamps or latches, to immobilize the mounted sample on the stage 163.

The sample platform 112 raises and lowers as the cover 103 opens and closes as is described elsewhere herein. The isolation transfer vessel 103 includes a lifting system or mechanism 209, best shown in FIGS. 2A-2B, for this purpose. A nonlimiting example of a lifting system 209 includes a linear bearing 212, a vertical shaft 215, a plurality of keys 218, and a mechanical lift 200. The mechanical lift 200 further includes a lifting linkage 224, and/or pivot 227.

The cover 103 and base 106 may form a sealed space around the sample platform 112. In some embodiments, the cover can be secured/sealed to the base 106 through the drive system 109. The sliding and securing mechanism of the cover 103 is controlled by the drive system 109. Embodiments of the drive system 109 may be implemented with a variety of mechanisms, such as gearing, worm gearing, chain and sprocket, belt drive, combinations thereof, or any other suitable mechanism(s).

As described above, and as a nonlimiting embodiment, the drive system 109 includes a vacuum-compatible motor 127 (e.g., a stepper motor), a pair of transmission gears 124 (e.g., spur gears), and two pairs of bevel gears 121 (e.g., worm driving parts). The transmission gear 124 of the vacuum-compatible motor 127 drives a second gear on a drive shaft 130 with bevel gears 121. The bevel gears 121 are positioned at or near opposing ends of the drive shaft 130, fixed on the box through a pair of shaft adaptors 151. The bevel gears 121 are mated to the corresponding bevel gears 121 of worm screws 133 at opposing ends of base 106. The corresponding bevel gear 121 is positioned at or near one end of the worm screw 133.

The worm screw 133 is threaded and mated to a sleeve adapter 136 that is also threaded. Sleeve adapters 136 at opposing ends of the base 106 are coupled to the cover 103. The sleeve adapters 136 move (left or right) along the worm screws 133 depending on whether the worm screws 133 are rotated clockwise or counterclockwise. While the worm screws 133 rotate, the worm screws 133 do not move axially or left or right in the view shown. The brackets 118 may secure the worm screws 133 in position and are unthreaded to allow the worm screws 133 to rotate without moving axially. Similarly, the brackets 118 may also be provided for the drive shaft 130 that do not allow the drive shaft 130 to move axially or up and down in the view shown.

FIGS. 2A-2B show a nonlimiting example of the lifting system 209 in the base 106. The lifting system 209 allows the sample platform 112 to rise and fall along with the translation of the cover 103. A nonlimiting embodiment provides four linear bearings 212 installed on the sample platform 112 that allow the vertical movement of the sample platform 112 along the vertical shafts 215 that are installed inside the base 106. Other embodiments may provide any number of linear bearing(s) 212 and vertical shaft(s) 215.

As the cover 103 is driven to the open position or slides open, the keys 218 on the underside of the cover 103 contact the lifting linkages 224. As the cover 103 continues to slide to the open position, the lifting linkages 224 cause the specimen platform 112 to rise. Due to the fixation of the lifting linkages 224 on the bottom of the base 106 through the pivot 227, the continued sliding of the cover 103 cause the other end of the lifting linkages 224 to lift the sample platform 112.

It shall be apparent to one of ordinary skill having the benefit of this disclosure that the opposite occurs as the cover 103 slides to the closed position. As the lifting linkages 224 rotate about the pivot 227, the force lifting the sample platform 112 is removed and a constant spring 225, shown in Fig., drives the sample platform 112 downward. The constant spring 225 biases the sample platform 112 in a downward direction and yields to the force exerted by the lifting linkage 224. The constant spring 225 is, by way of example and illustration, but one means of biasing the sample platform 112 in the downward direction. Some embodiments may instead employ structural equivalents that perform the function of biasing the sample platform 112 downward. In still other embodiments, the sample platform 112 lowers through the force of gravity instead of a biasing means. It should be noted that the lifting mechanism 209 does not require its own actuator or motor, and instead utilizes the sliding of the cover. Such embodiments may be considered to be combined drive and lift systems within the scope and spirit of the present invention.

As mentioned above, the isolation transfer vessel 100 in its various embodiments may be used in both in-chamber and in chamber-free analyses. In the specific application of embodiments of the multi-purpose isolation transfer vessel 100, the process or method differs between in-chamber and chamber-free analysis. The embodiments of the process or methods discussed herein are applicable to any embodiments of the isolation transfer vessels discussed and may be applicable to other isolation transfer vessels.

For in-chamber characterization (e.g., Scanning Electron Microscope (“SEM”), Focused Ion Beam (“FIB”) slice-and-view tomography), the transfer vessel is sealed during transit to the chamber of an analytical instrument. Then, as vacuuming the chamber or filling it with inert gas for a preferred testing environment, the drive system 109 opens the cover 103 and the lifting linkages 224 lift the sample platform 112 outside of the base 106. Thus, the specimen (not shown) is placed on the highest position attainable for the transfer vessel. This highest attainable position effectively shortens the working distance to the analysis and sputtering guns that usually equipped with in-chamber analytical instruments.

After completing the characterization, the vacuum-compatible motor 127 controls the cover 103 closing and brings down the sample platform 112, returning to the sealing status. It should be noted that some analytical instruments (e.g., FIB) stringently require a low working distance. Embodiments of the vessel and methods discussed herein may allow placement within a low working distance, such as <5 mm, in some embodiments.

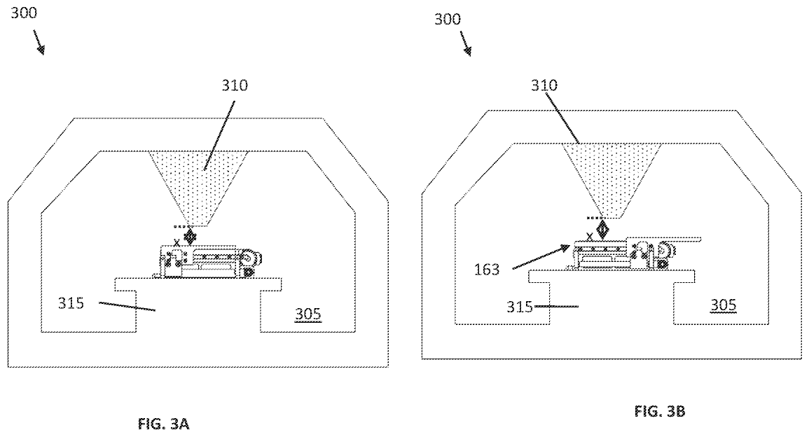

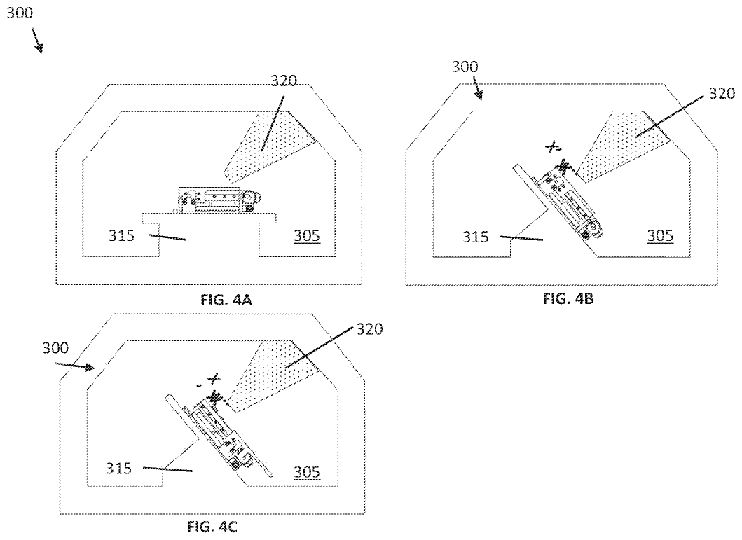

FIG. 3A-FIG. 3B and FIG. 4A-FIG. 4C show nonlimiting examples of the application of the isolation transfer vessel 100 in a diagnostic tool 300 having an air-free chamber 305. The diagnostic tool 300 in the illustrated embodiment includes a scanning electron microscope (“SEM”, not shown) that transmits a SEM beam 310, the operation procedures for which were described previously. While an SEM example is specifically shown, such operation is similar for other diagnostic tools and/or analytical instruments that do not have stringent working distance requirements.

The isolation transfer vessel 100 is deposited in the air-free chamber 300 upon the pedestal 315 to which it is secured in a conventional manner and using conventional means not shown. The isolation transfer vessel 100 is opened by translating the cover 103 to the open position to expose the sample stage 163 as shown and as described above. The sample can then be analyzed/characterized using the SEM. The results of the analysis/characterization are then stored or transmitted as desired for use.

The diagnostic tool 300 also includes a FIB (not shown) transmitting a FIB beam 320. FIG. 3B shows nonlimiting examples of the application of the isolation transfer vessel 100 in the focused-ion beam (“FIB”) tomography. FIB tomography has strict limitations for the working distance between the FIB beam and the sample. The operations of the isolation transfer vessel 100 are more involved than in the SEM or other processes that do not need low working distances in order to accommodate the FIB low working distances.

The isolation transfer vessel 100 is placed in the chamber 305 upon the pedestal 315 to which the isolation transfer vessel 100. The isolation transfer vessel 100 is secured to the pedestal 315 in a conventional manner and using conventional means not shown. This may be performed as a part of the SEM operation described above or performed independently.

After vacuuming the chamber 305 and/or filling the chamber 305 with an inert gas (not shown), the pedestal 315, or at least the top surface 325 of the pedestal 315, is rotated or tilted to a certain desired angle α (not shown) relative to the vertical. This action also tilts the isolation transfer vessel 100 and the mounted sample (not separately shown) for exposure to the FIB beam 320. The cover 103 of the isolation transfer vessel 100 is then opened, which lifts the sample platform 112 as discussed above. The sample is then positioned at the designated working distance range x for the FIB analysis. Note that alternative embodiments may open the isolation transfer vessel 100 prior to tilting the pedestal 315.

While a SEM example and a FIB example are specifically shown, such operations are similar for other analytical instruments, including those that have stringent working distance requirements. Note that some analytical instruments may not require rotation of the isolation transfer vessel 100 to a desired angle α, and such step may be omitted accordingly. Those in the art having the benefit of this disclosure will be able to readily modify the process described herein for applicability to other types of diagnostic tools and/or analytical instruments.

Returning to FIG. 1B, for embodiments involving chamber-free instruments, the cover 103 may include the observation window 115. Non-limiting examples of chamber-free instruments or tools include instruments and tools used for Raman spectroscopy and X-ray diffraction analysis. Moreover, most of the chamber-free diagnostic techniques permitted with comparatively long working distance than the in-chamber tests. Therefore, it generally is not necessary to open the vessel and raise the platform to reach the working distance requirement. The sample can remain sealed for diagnosis.

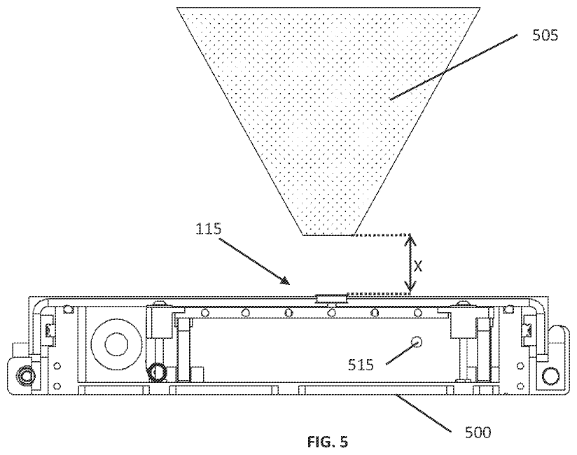

FIG. 5 shows the application of the isolation transfer vessel 103 in a chamber-free device. The chamber-free device is represented by its pedestal 500 on which the isolation transfer vessel 103 is disposed. Note the analytical beam 505 generated by the chamber-free device interacting with the sample (not separately shown) through the observation window 115. The operation procedures are more fully described previously above.

Also shown in FIG. 5 that have not been previously shown are cutouts 515, which serve as cable feedthroughs. Some embodiments will include various types of electronics (not shown) associated with the sample stage 163 to sense various parameters and/or characteristics of the sample during examination. The cutouts 515 permit cables for data and power transmission to and from the electronics used to sense the sample. Those in the art having the benefit of this disclosure will appreciate that the cutouts 515 are sealed against fluid flow to keep the isolation transfer vessel 103 air-free.

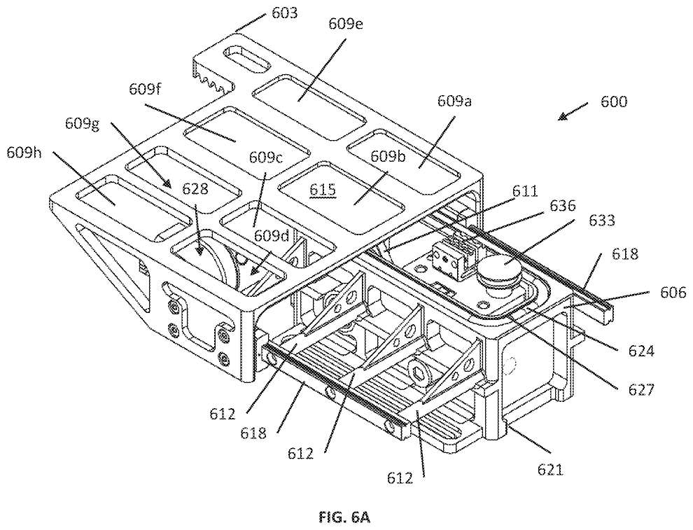

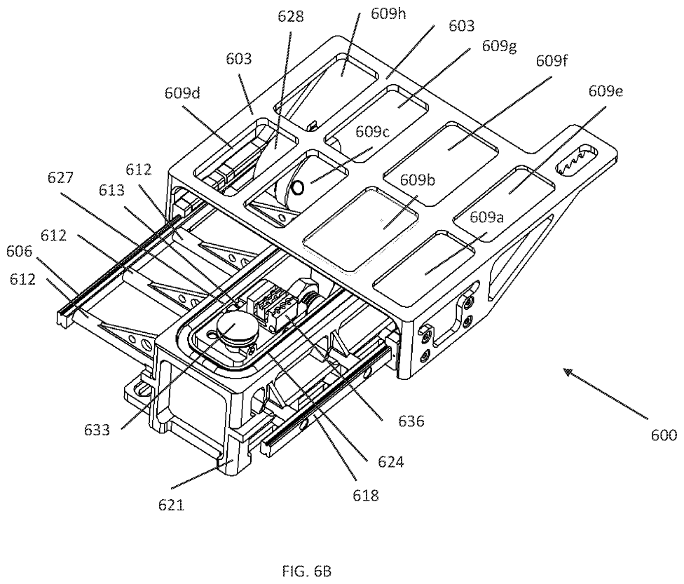

FIG. 6A and FIG. 6B are top, perspective elevational views of an isolation transfer vessel 600 in an open position in accordance with one or more embodiments. The isolation transfer vessel 600 includes a cover 603 and a base 606. Both the cover 603 and the base 606 have been “skeletonized”, that is, have had significant amounts of material removed for weight and cost savings. So, for example, the cover 603 includes cutouts 609a-609h. Similarly, base 606 is no longer a basin, but instead has a framework including, for example, the struts 612 the rails 618, and the sample platform 621. Those in the art will appreciate that cost/weight savings may be achieved in other ways in other embodiments or omitted altogether.

In this particular embodiment, the cutout 609b also serves as a window opening and is sealed by a translucent pane 615. (In some embodiments, one or all of the cutouts 609a-609h may serve as window openings sealed by translucent panes 615.) The sample platform 621 defines a recess 624 in which a sealing element 627 (e.g., an O-ring) resides. The cover 603 is driven by a drive system such as that discussed above, including a motor 628, to reciprocate on the rails 618 between an open position shown and a closed position not shown.

The sample platform 621 raises and lowers via a lift mechanism and a constant spring as described above, neither of which is shown in FIGS. 6A-6B, as the cover 603 reciprocates between the open and closed positions. Thus, when the cover 603 is in the closed position, the sealing element 627 seals against the underside of the ribs 630 of the cover 603. This seal maintains the air-free environment about the sample stage 633, 636 during transport as described above.

In this embodiment, the sample stages 633, 636, rather than the sample platform 621 as a whole, raise and lower as the cover 603 reciprocates between the open and closed positions. The lift mechanism includes a lifting linkage 611 and a constant-force spring 613. The constant force spring 613 implements the synchronized sample stages 633, 636 raising and lowering when the cover 603 opens and closes. The lifting rod 611 and constant-force spring 613 are fixed on sample platform 621. As cover 603 is opening, the key (not shown) on the cover 603 pulls the lifting rod 611 and in turn, raises the sample stages 633, 636.

The raising of the sample stages 633, 636 permits samples on the sample stages 633 and 636 to rise higher than the ribs 630 of the cover 603, on the highest position of the whole system. As the cover 603 is closing, the cube protrudes on cover 603 releasing the lifting rod 611, and the constant-force spring 613 pulls down the sample stage 633. When cover 603 is in the closed position, the sealing element 627 seals against the underside of the ribs 630 of cover 603. This seal maintains the air-free environment about the sample stage 633 during transport as described above.

Also included on the sample platform 621 and the sample stages 633, 636. The sample stage 636 includes the electronics for this particular embodiment. The electronics may include, for example, a heater, a thermal sensor, or a combination of the two. Those in the art having the benefit of this disclosure will appreciate still other types of electronics that may be used in addition to or in lieu of those set forth herein.

As the vessel is compatible with multiple diagnostic tools, in-chamber test can be implemented right after the chamber-free measurement or vice versa. The sample that is installed on the sample stage of the isolation transfer vessel can go through a series of characterizations without releasing from the sample stage, providing multi-dimensional experiment evidence for the fundamental study of coupling interactions.

The multi-purpose isolation transfer vessel disclosed herein offers a number of improvements in several respects compared to many existing techniques. For example, conventional transfer vessels for protecting sensitive substances from the sampling environment during movement to/from the analytical instrument are limited to a specific type of analytical device. Embodiments of transfer vessels discussed herein provide a controlled atmosphere that can transit between several mainstream analytical instruments, including but not limited to Scanning Electron Microscope, Focused Ion Beam slice-and-view tomography, X-ray diffraction spectroscopy, Raman spectroscopy, etc.

Embodiments of transfer vessels discussed herein also can protect the air-sensitive sample for FIB analysis, which is significant technique in the materials sciences for the fundamental morphological studies. This technique favors having the sample located at the highest position of the sample stage possible, providing barriers for the conventional protective atmosphere transfer vessel. A lift mechanism setup (e.g., FIG. 2) that allows the sample stage of the transfer vessel to be elevated when desired, which provides a feasible solution for the Focused Ion Beam analysis of the sample in a hermetically sealed transfer vessel. Prior convention transfer vessels do not allow for FIB analysis due to the inability to satisfy the working distance constraints.

Additionally, embodiments of the transfer vessel allow multi-physics characterizations on an individual sample with multiple analytical instruments. As such, the embodiments permit the combination of multiple analytical measurements, such as two or more, on different analytical instruments, which facilitates an in-depth understanding of the coupling structural-chemical-mechanical properties of the sample. Thus, embodiments of the transfer vessel can be used as an intermediate junction for the future automated and programmable multi-technique diagnostics, enabling the efficient utilization of the analytical instrument resources.

Note that not all embodiments will necessarily manifest all these improvements. Furthermore, to the extent that various embodiments manifest one or more of these improvements, they will not necessarily possess them to the same degree. Those skilled in the art having the benefit of this disclosure may appreciate still other improvements

The term “diagnostic tool” is be construed broadly to include not only diagnostic tools, but also diagnostic devices, analytical instruments, analytical tools, analytical devices, examination tools, examination instruments, examination devices, and other types of tools, instruments, and equipment that may be used to examine a sample in an air-free environment during a process. All such terms are used interchangeably herein. Non-limiting examples of diagnostic or examination techniques disclosed herein include but are not limited to SEM, FIB, Raman spectroscopy, and X-ray diffraction. However, those skilled in the art will appreciate still other types of diagnoses, examinations, and/or analyses that may be conducted by still other diagnostic tools with which the presently disclosed technique may be used, now or in the future.

The term “air-free” as used herein mean devoid of ambient atmosphere or operative at a lower than ambient pressure. In air-free chambers, this may be attained in any suitable way known to the art. For instance, some embodiments may induce a vacuum in the air-free chamber after the isolation transfer vessel 103 is deposited therein. In other embodiments, after the isolation transfer vessel 103 is deposited in the air-free chamber, the air-free chamber may be flooded with an inert gas. Those skilled in the art having the benefit of this disclosure may appreciate still other ways in which an environment devoid of ambient atmosphere may be attained. Conversely, the term “air-filled” means that ambient atmosphere is present.

Throughout this disclosure various directional terms are employed to describe various aspects of the isolation transfer vessel 103 and its operations. These may include, for example, “up”, “down”, “raise”, “lower”, “vertical”, “lateral”, and others. These directional terms are defined relative to the force of the Earth's gravity. Thus, terms such as “up” and “raise” are coincident with and opposed to the force of gravity whereas terms such as “down” and “lower” are coincident with and in conjunction with the force of gravity.

The nonlimiting examples discussed are included to demonstrate particular aspects of the present disclosure. It should be appreciated by those of ordinary skill in the art that the methods described in the examples that follow merely represent illustrative embodiments of the disclosure. Those of ordinary skill in the art should, in light of the present disclosure, appreciate that many changes can be made in the specific embodiments described and still obtain a like or similar within the scope of this disclosure.

Accordingly, in a first embodiment, an isolation transfer vessel, comprises: a base, a cover, a drive system, a sample platform disposed within the base, and a mechanical lift. The drive system, in use, translates the cover between an open position and a closed position relative to the base, the cover forming a hermetic seal with the base when in the closed position. The mechanical lift raises the sample platform as the cover translates to the open position and permits the sample platform to lower as the cover translates to the closed position.

In a second embodiment, in the isolation transfer vessel of the first embodiment, the base is a basin defining a top opening; the basin includes a lip at a top thereof, the lip defining a continuous recess circumscribing the opening for the basin; and a sealing element is disposed within the recess to hermetically seal the juncture between the cover and the base when the cover is in the closed position.

In a third embodiment, in the isolation transfer vessel of the first embodiment, the base is a skeletonized framework; the sample platform defines a continuous recess circumscribing a portion thereof including the sample stage; and a sealing element is disposed within the recess to hermetically seal the juncture between the cover and the base when the cover is in the closed position.

In a fourth embodiment, in the isolation transfer vessel of the first embodiment, an observation window is positioned over the sample platform when the cover is in the closed position.

In a fifth embodiment, in the isolation transfer vessel of the fourth embodiment, the observation window comprises a window opening defined by the cover and a translucent pane closing the window opening to maintain the hermetic seal when the cover is in the closed position.

In a sixth embodiment, in the isolation transfer vehicle of the first embodiment, the base is a basin, the basin includes a plurality of vertical shafts extends upwardly from a floor of thereof, a plurality of tubular legs extends downwardly from the sample platform; and the tubular legs reciprocate on the vertical shafts as the sample platform raises and lowers.

In a seventh embodiment, in the isolation transfer vehicle of the first embodiment, the mechanical lift comprises a lifting linkage pivotably mounted to the base and engaging the cover and the sample platform and the lifting linkage pivots as the cover translates between the open position and the closed position to lift the sample platform and to permit the sample platform to lower.

In an eighth embodiment, in the isolation transfer vehicle of the sixth embodiment, the lifting linkage includes a first end, and a second end, and a pivot between the first end and the second end, the cover includes a first key on a bottom side thereof engaging the first end of the lifting linkage, and the sample platform includes a second key on a bottom side thereof engaging the second end thereof.

In a ninth embodiment, in the isolation transfer vehicle of the first embodiment, the drive system comprises: a vacuum-compatible motor and a worm screw engaging the vacuum-compatible motor and the cover to drive the cover between the open position and the closed position.

In a tenth embodiment, a method for use in inspecting devices on diagnostic tools, comprises: opening a hermetically sealed isolation transfer vessel in an air-free environment, the opening of the isolation transfer vessel mechanically raising a sample platform and exposing the interior of the isolation transfer vessel to the air-free environment; disposing a mounted sample on the sample platform; closing the isolation transfer vessel, the closing of the isolation transfer vessel allowing the sample platform to lower and hermetically sealing the mounted sample on the sample platform within the isolation transfer vessel; transporting the closed isolation transfer vessel in which the mounted sample is hermetically sealed to a first diagnostic tool; and inspecting the mounted sample using the first diagnostic tool.

In an eleventh embodiment, in the method of the tenth embodiment, transporting the closed isolation transfer vessel to the first diagnostic tool includes depositing the closed isolation transfer vessel in an air-free chamber and inspecting the mounted sample using the first diagnostic tool includes: opening the hermetically sealed isolation transfer vessel in the air-free chamber, the opening of the isolation transfer vessel mechanically raising the sample platform and exposing the interior of the isolation transfer vessel; and applying an inspection technology to the exposed mounted sample.

In a twelfth embodiment, in the method of the eleventh embodiment, the inspection technology is a scanning electron microscope beam.

In a thirteenth embodiment, the method of the eleventh embodiment further comprises applying a second inspection technology to the exposed mounted sample.

In a fourteenth embodiment, in the method of the thirteenth embodiment, the second inspection technology is a focused ion beam.

In a fifteenth embodiment, in the method of the thirteenth embodiment, the inspection technology is a scanning electron microscope beam and the second inspection technology is a focused ion beam.

In a sixteenth embodiment, the method of the eleventh embodiment further comprises: closing the isolation transfer vessel to hermetically seal the mounted sample within; transporting the closed isolation transfer vessel in which the mounted sample is hermetically sealed to a second diagnostic tool; and inspecting the mounted sample using the second diagnostic tool.

In a seventeenth embodiment, in the method of the tenth embodiment, transporting the closed isolation transfer vessel to the first diagnostic tool includes depositing the closed isolation transfer vessel on the tool in an air-filled environment; and inspecting the mounted sample using the first diagnostic tool includes applying an inspection technology to the mounted sample through an observation window in the closed isolation transfer vessel.

In an eighteenth embodiment, the method of the seventeenth embodiment further comprising applying a second inspection technology to the exposed mounted sample.

In a nineteenth embodiment, the method of the seventeenth embodiment further comprises: transporting the closed isolation transfer vessel in which the mounted sample is hermetically sealed to a second diagnostic tool; and inspecting the mounted sample using the second diagnostic tool.

In a twentieth embodiment, the method of the tenth embodiment further comprises transporting the closed isolation transfer vessel in which the mounted sample is hermetically sealed to a second diagnostic tool and inspecting the mounted sample using the second diagnostic tool.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. An isolation transfer vessel, comprising:
a base;
a cover;
a drive system that, in use, translates the cover between an open position and a closed position relative to the base, the cover forming a hermetic seal with the base when in the closed position;
a sample platform disposed within the base; and
a mechanical lift that raises the sample platform as the cover translates to the open position and permits the sample platform to lower as the cover translates to the closed position.

2. The isolation transfer vessel of claim 1, wherein:
the base is a basin defining a top opening;
the basin includes a lip at a top thereof, the lip defining a continuous recess circumscribing the opening for the basin; and
a sealing element is disposed within the recess to hermetically seal the juncture between the cover and the base when the cover is in the closed position.

3. The isolation transfer vessel of claim 1, wherein:
the base is a skeletonized framework;
the sample platform defines a continuous recess circumscribing a portion thereof including the sample stage; and
a sealing element is disposed within the recess to hermetically seal the juncture between the cover and the base when the cover is in the closed position.

4. The isolation transfer vessel of claim 1, further comprising an observation window positioned over the sample platform when the cover is in the closed position.

5. The isolation transfer vessel of claim 4, wherein the observation window comprises:
a window opening defined by the cover; and
a translucent pane closing the window opening to maintain the hermetic seal when the cover is in the closed position.

6. The isolation transfer vehicle of claim 1, wherein:
the base is a basin;
the basin includes a plurality of vertical shafts extending upwardly from a floor of thereof;
a plurality of tubular legs extends downwardly from the sample platform; and
the tubular legs reciprocate on the vertical shafts as the sample platform raises and lowers.

7. The isolation transfer vehicle of claim 1, wherein:
the mechanical lift comprises a lifting linkage pivotably mounted to the base and engaging the cover and the sample platform; and
the lifting linkage pivots as the cover translates between the open position and the closed position to lift the sample platform and to permit the sample platform to lower.

8. The isolation transfer vehicle of claim 6, wherein:
the lifting linkage includes a first end, and a second end, and a pivot between the first end and the second end;
the cover includes a first key on a bottom side thereof engaging the first end of the lifting linkage; and
the sample platform includes a second key on a bottom side thereof engaging the second end thereof.

9. The isolation transfer vehicle of claim 1, wherein the drive system comprises:
a vacuum-compatible motor; and
a worm screw engaging the vacuum-compatible motor and the cover to drive the cover between the open position and the closed position.

10. A method for use in inspecting devices on diagnostic tools, comprising:
opening a hermetically sealed isolation transfer vessel in an air-free environment, the opening of the isolation transfer vessel mechanically raising a sample platform and exposing the interior of the isolation transfer vessel to the air-free environment;
disposing a mounted sample on the sample platform;
closing the isolation transfer vessel, the closing of the isolation transfer vessel allowing the sample platform to lower and hermetically sealing the mounted sample on the sample platform within the isolation transfer vessel;
transporting the closed isolation transfer vessel in which the mounted sample is hermetically sealed to a first diagnostic tool; and
inspecting the mounted sample using the first diagnostic tool.

11. The method of claim 10, wherein:
transporting the closed isolation transfer vessel to the first diagnostic tool includes depositing the closed isolation transfer vessel in an air-free chamber; and
inspecting the mounted sample using the first diagnostic tool includes:
opening the hermetically sealed isolation transfer vessel in the air-free chamber, the opening of the isolation transfer vessel mechanically raising the sample platform and exposing the interior of the isolation transfer vessel; and
applying an inspection technology to the exposed mounted sample.

12. The method of claim 11, wherein the inspection technology is a scanning electron microscope beam.

13. The method of claim 11, further comprising applying a second inspection technology to the exposed mounted sample.

14. The method of claim 13, wherein the second inspection technology is a focused ion beam.

15. The method of claim 13, wherein:
the inspection technology is a scanning electron microscope beam; and
the second inspection technology is a focused ion beam.

16. The method of claim 11, further comprising:
closing the isolation transfer vessel to hermetically seal the mounted sample within;
transporting the closed isolation transfer vessel in which the mounted sample is hermetically sealed to a second diagnostic tool; and
inspecting the mounted sample using the second diagnostic tool.

17. The method of claim 10, wherein:
transporting the closed isolation transfer vessel to the first diagnostic tool includes depositing the closed isolation transfer vessel on the tool in an air-filled environment; and
inspecting the mounted sample using the first diagnostic tool includes applying an inspection technology to the mounted sample through an observation window in the closed isolation transfer vessel.

18. The method of claim 17, further comprising applying a second inspection technology to the exposed mounted sample.

19. The method of claim 17, further comprising:
transporting the closed isolation transfer vessel in which the mounted sample is hermetically sealed to a second diagnostic tool; and
inspecting the mounted sample using the second diagnostic tool.

20. The method of claim 10, further comprising:
transporting the closed isolation transfer vessel in which the mounted sample is hermetically sealed to a second diagnostic tool; and
inspecting the mounted sample using the second diagnostic tool.
